(19) United States
(12) Patent Application Publication
(10) Pub. No.: US 2003/0234081 A1
(43) Pub. Date: Dec. 25, 2003

(54) Assembly drum for manufacturing tires

(76) Inventors: Jacques Auclair, Cournon-D'Auvergne (FR); Daniel Macheffe, Veyre Monton (FR)

Correspondence Address: BAKER & BOTTS, 30 ROCKEFELLER PLAZA, NEW YORK, NY, 10112

(21) Appl. No.: 10/608,658

(22) Filed: Jun. 27, 2003

Related U.S. Application Data
(63) Continuation of application No. PCT/EP01/15188, filed on Dec. 21, 2001.

(30) Foreign Application Priority Data
Dec. 29, 2000 (FR) 00/17346

(51) Int. Cl. B60C 9/00

(52) U.S. Cl. 156/394.1

(57) ABSTRACT

An assembly drum for tire manufacture includes a body (2) mounted on a central shaft (6) and having a generally cylindrical surface (3), for receiving the products to be assembled to make up a tire, as well as axially spaced shoulders (4, 5). The shoulders (4, 5) are movable axially and radially between a retracted position of the drum (1), in which the reception surface (3) has a minimum diameter and axial length, and a working position of the drum, in which the diameter and axial length of the reception surface (3) are very much greater than those in the retracted position. The shoulders respectively carry means (15, 16) for holding the products making up the tire in contact with the shoulders.

### CROSS REFERENCE TO RELATED APPLICATIONS

This is a continuation of international application PCT/EP01/15188 filed Dec. 21, 2001, which was published in French on Jul. 11, 2002 as international publication WO 02/053355 and which claims priority of French application 00/17346 filed Dec. 29, 2000.

### BACKGROUND OF THE INVENTION

1. The Field of Invention

The present invention concerns an assembly drum for manufacturing tires. The invention concerns more particularly the manufacture of tires such as those used on aircraft or certain heavy vehicles, which tires comprise a carcass reinforcement having several reinforcement plies normally referred to as carcass plies and several reinforcement bead wires in each of the tire beads, one of the carcass reinforcements being wound around each bead wire forming an upturn. However, it will be clear from the following that the invention can also apply to the manufacture of tires having only one reinforcement bead wire or having no reinforcement bead wire.

2. The Related Art

One of the difficulties in manufacturing such tires having many bead wires lies in the successive placing of carcass plies and bead wires on an assembly drum while producing the many upturns. To this end, use is generally made of assembly drums having shoulders on which the bead wire or wires are placed during assembly by a lateral approach to the shoulders, the difficulty lying in keeping the products in contact with these shoulders.

It should be noted that such drums can directly use bead wires or semi-finished products manufactured separately, which products may consist of the bead wire surmounted radially by a profiled section made of rubber mix. Hereinafter, the term bead wire complex will be used for a bead wire alone or a bead wire surmounted by a profiled section made of rubber mix, and possibly also including a product for coating the bead wire such as another profiled section made of rubber mix or a rubber ply comprising cables.

Some solutions are based on the use, in combination with the drum, of a device for holding the products to be assembled on the drum. Thus, U.S. Pat. No. 2,605,198 describes a non-expansible assembly drum with shoulders which has such a device. During assembly, a first previously stretched carcass ply is placed on the drum, its peripheral ends simply being folded down towards the inside of the drum by means of a rolling device.

The bead-wire complexes are fed by devices which can be moved axially with respect to the drum in order to be placed in contact with the carcass ply respectively on each shoulder and held in place by means of this same device. This holding in position of the bead-wire complexes is essential to ensure contact of the peripheral ends of the carcass ply with the shoulders. The operation is identical for feeding each bead-wire complex, which makes the step of turning over each carcass ply on the corresponding bead-wire complex particularly tricky. This is because it is then necessary to maintain the axial position of the bead-wire complex, in addition to its radial position, in order to ensure abutment on the shoulders of all of the plies and bead-wire complexes already in place, while effecting the new turning over precisely.

In order to simplify and make more precise the steps of turning over the carcass ply around the bead wire; other solutions use a drum on which the shoulders consist of pieces that are attached with respect to the drum and that are capable of being removed easily. This is because in this case the peripheral ends of the first carcass ply are glued onto the shoulders of the drum, which settles the problem of the axial holding of the products against the shoulders. It is then the operation of removing the tire which becomes a problem, and it is necessary, for each raw tire assembled, to remove the shoulders from the drum. It is clear that this process can only be manual.

### SUMMARY OF THE INVENTION

The present invention is aimed at mitigating all the aforementioned drawbacks of the prior art.

According to the invention, an assembly drum for tire manufacture includes a body mounted on a central shaft and having a generally cylindrical surface for receiving the products to be assembled as well as shoulders, the shoulders being capable of moving axially and radially between a retracted position of the drum, in which the generally cylindrical reception surface has a minimum diameter and axial length, and a working position of the drum, in which the diameter and the axial length of the reception surface are very much greater than those in the retracted position, the shoulders respectively carrying means for holding the products making up the tire in contact with the shoulders.

This provision makes it possible to produce a drum without any additional device, in which the retraction of the drum in order to take off the assembled tire does not necessitate dismantling, the holding means also making it possible to hold the products making up the tire in contact with the shoulders during assembly.

### BRIEF DESCRIPTION OF THE DRAWINGS

Other characteristics and advantages of the invention will emerge from the following description of an example embodiment of an assembly drum and its method of use in accordance with the invention, with reference to the accompanying drawing in which:

FIGS. 1A and 1B are axial half-sections of an embodiment of the drum according to the invention in the working position of the drum and in the retracted position of the drum, respectively; and

FIGS. 2A and 2B are radial half-sections of the drum according to the invention along the line II-II shown in FIGS. 1A and 1B, respectively.

### DETAILED DESCRIPTION OF EXEMPLARY EMBODIMENTS

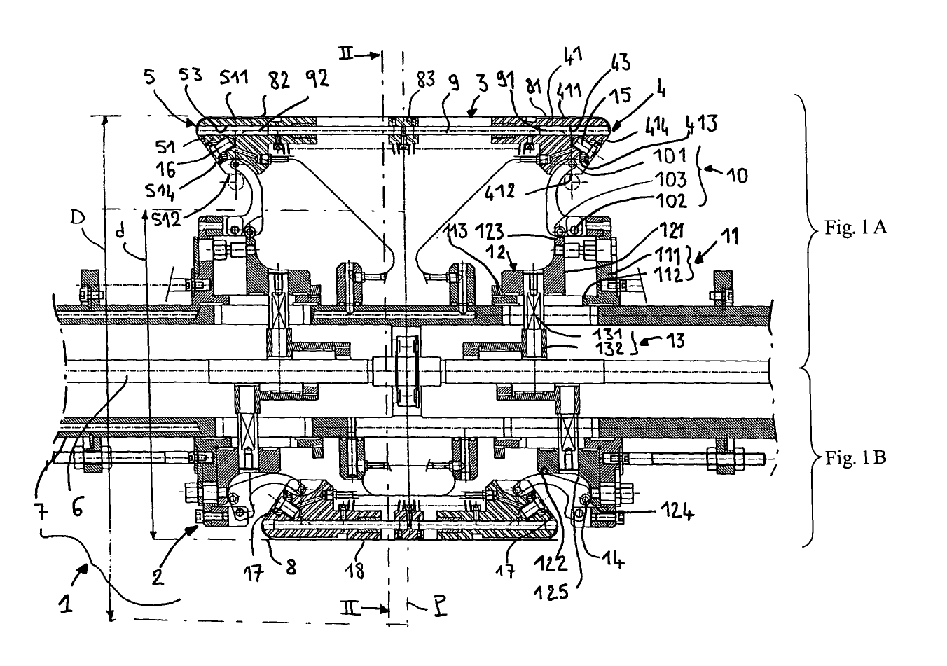

According to FIGS. 1A and 1B, the drum 1 has a body 2 having a generally cylindrical surface 3 for receiving products to be assembled and axiable-spaced shoulders 4 and 5. The body 2 is mounted on a central screw shaft 6 by a means of a barrel 7.

The drum 1 has two different radial positions:

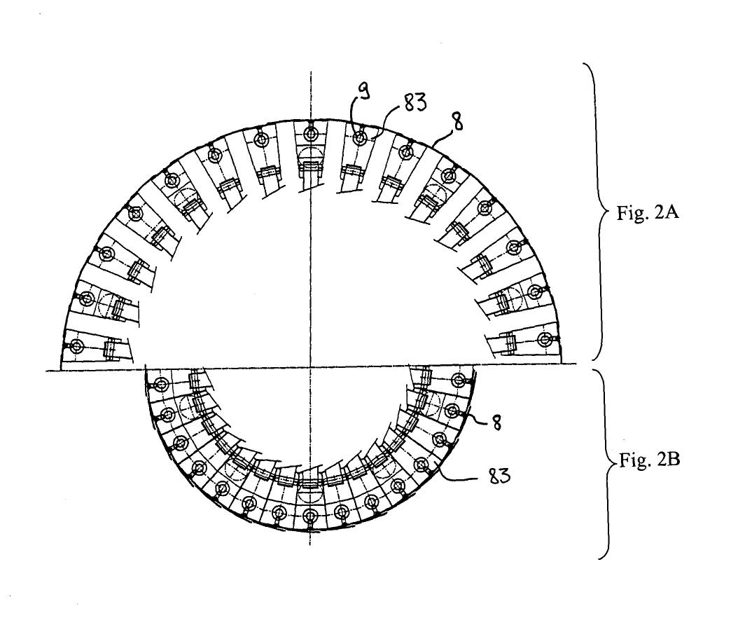

a retracted position (corresponding to the removal of a tire), shown in FIGS. 1A and 2A, in which the diameter of the reception surface 3 is at a minimum, d, and in which the shoulders 4 and 5 are axially positioned close to each other; and

a working position or expanded position, shown in FIGS. 1B and 2B, in which the assembly of the products making up the tire is effected, in which the reception surface 3 has a very much greater diameter D and in which the shoulders 4 and 5 are spaced much further away from each other axially.

This is because the shoulders 4 and 5 consist respectively of lateral elements 41 and 51 juxtaposed in the retracted position of the drum 1 and distributed regularly over the entire surface of the drum. Each element 41, 51 has a substantially trapezoidal shape seen in axial section, one of the bases 411, 511 of the trapezium partially constituting the reception surface 3, while the other base 412, 512 affords the connection and articulation of the elements 41, 51 with respect to the barrel 7, as will be seen in more detail below. The surfaces 414, 514 of the elements 41, 51 define the shoulders 4, 5, respectively.

The reception surface 3 thus comprises the surfaces 411 and 511 and the surface of tiles 8 which extend circumferentially between the surfaces 411 and 511, with their axial ends 81 and 82 partially covering the surfaces 411, 511. Each tile 8 is carried by an internal support 83 fixed to it, which support 83 itself has an axially extending rod 9 passing through it. Each end 91, 92 of the rod 9 slides in a corresponding bore 43, 53 carried by each facing lateral element 41, 51, so that the ends 91 and 92 of the rods 9 are always engaged in the bores 43 and 53 whatever the position of the drum 1.

The number of tiles 8 corresponds to the number of lateral elements 41, 45. The tiles 8 greatly overlap each other circumferentially in the retracted position of the drum 1 and circumferentially overlap each other slightly in the expanded position of the drum. It is clear that the tiles 8 are integral with the radial movements of the lateral elements 41, 51.

Some lateral elements 41, 51 carry vacuum valves 15, 16 opening out through the surfaces 414, 514 in order, when they are actuated, to hold the products placed on the shoulders 4, 5. It is not necessary to position such a valve in each element, it is enough to distribute them regularly, for example every three or four lateral elements. The pipes (not shown) for operating the vacuum, connected to these valves, pass inside the drum. This provision avoids the bonding or fitting of a mechanical device for holding the products in position on the drum and, in combination with the drum retraction which will be detailed later, affords easy removal of a tire once assembled on the drum.

Each lateral element 41, 51 is covered with a first sleeve 17. A second sleeve 18 covers the entire reception surface 3. See, FIG. 1B.

The lateral elements 41 forming the shoulder 4 and their articulation and the lateral elements 51 forming the shoulder 5 with their articulation are identical and symmetrical with respect to the radial plane passing through the center of the drum 1. Therefore, only the connection and articulation of one lateral element 41 with respect to the barrel 7 will be described in detail, it being understood that this description is applicable to the other elements 41, 51 as well.

On the base 412 of each lateral element 41 there is pivotally mounted one end 101 of a rocker arm 10 on the path formed by a groove 413 in the element 412 in the form of an arc of a circle, so that the pivoting of the end 101 of the rocker arm causes an axial and radial movement of the element 41, which thus keeps the same orientation.

The other end 102 of each rocker arm 10 is articulated on the external peripheral edge of a ring 111 fixed to a support 11 mounted rigidly on the barrel 7. This annular support 11 is in fact fixed to the barrel 7 by a nut and screw system which can allow its axial adjustment according to the size of the tire to be assembled.

The support 11 has, in addition to the annular part 111, a cylindrical part 112 situated axially inwardly of the drum 1 with respect to the ring 111. A slide 12 is mounted on the part 112 for axial translation, which part 112 carries a stop 113 limiting the movement of the slide 12 towards the inside of the drum 1.

The slide 12 is actuated by means of a transmission finger 131 extending in the radial direction and located in a housing carried by the slide 12 (FIG. 1B). The finger 131 is mounted on a ballscrew system 13, the casing 132 of which is carried by the central shaft 6. The shaft 6 is motorized by two drives independently effecting the movement of the casing 132 in order to control the axial movement of the slide 12 or to rotate the whole of the drum 1 about its axis. The slide 12 is thus able to move between a position in which one of its surfaces 121 is in contact with the ring 111 (FIG. 1B) and a position in which the surface 121 is axially spaced apart from the ring 111 (FIG. 1A). It is clear that other means of actuating the slide 12 could be envisaged, such as the use of a ram.

The peripheral edge of the slide 12 disposed at the radially outermost end of the surface 121 with respect to the center of the drum constitutes a cam 123 for actuating each rocker arm 10. The cam 123 cooperates with a roller 14 carried by an elbow 103 formed on each rocker arm 10. The peripheral edge of the slide terminates radially towards the outside in a cylindrical “upper” stop surface 124 for each rocker arm 10. The profile of the cam 10 is produced according to the required speed of lifting of the drum towards its working position.

The slide 12 also carries, situated axially towards the inside of the drum, a recess 125 allowing the positioning of each rocker arm 10 in contact with it in the retracted position of the drum (FIG. 1B). For this purpose, the slide 12 carries at this recess 125 a cylindrical surface 122, radially and axially closer to the center of the drum 1 than the surface 124, for the “bottom” abutment of each rocker arm 10.

Without departing from the scope of the invention, other systems for controlling the rocker arms 10 can be envisaged such as, for example, a rack and pinion system.

A description will be given very succinctly hereinafter of the functioning of the drum 1 for movement from its retracted position to the working position and vice versa, concentrating on the side of the drum 1 situated to the right of its plane of symmetry P depicted in FIGS. 1A and 1B, the rest being apparent from the symmetry with respect to the plane P.

With the transmission finger 131 in its position furthest away axially from the center of the drum 1, the slide 12 is in contact with the ring 111 through its surface 121 and each rocker arm 10 is in the idle position; that is to say, the end 101 is in the radially position closest to the center of the drum 1 and part of the rocker arm 10 is in abutment with the surface 122 of the slide 12 (FIG. 1B). The drum 1 is thus in the retracted position, the elements 41 being axially and radially closest to the center of the drum.

By actuating the drive of the shaft 6 relative to the ballscrew system, the slide 12 is driven axially by the transmission finger 131 so as to move away from the ring 111 by sliding on the part 112 of the support 11. This movement breaks the contact between each rocker arm 10 and the stop surface 122 and affords the articulation of each rocker arm. The roller 14 of each rocker arm 10 thus follows the cam 123 until it reaches the cylindrical surface 124, which stops its travel (FIG. 1A). The other end 101 of each rocker arm, co-operating with the groove 413, causes in its articulation the axial and radial movement of each element 41 axially and radially towards the outside of the drum of each element 41.

The elbows 103 on the rocker arms 10 rest by means of the rollers 14 on the cylindrical surface 124 to determine the working position of the drum 1 in which the lateral elements 41 are radially and axially furthest away from the center of the drum 1.

What is claimed is:

1. An assembly drum for tire manufacture, comprising:
a central shaft;
a body mounted on said shaft and having a generally cylindrical outer surface for receiving products to be assembled to make up a tire;
a pair of axially spaced shoulders on said body, said shoulders defining at least in part said generally cylindrical outer surface and being radially and axially movable between a retracted position of the drum, in which said generally cylindrical outer surface has a minimum diameter and a minimum axial length, and a working position of the drum, in which the diameter and axial length of said generally cylindrical outer surface are greater than in the retracted position; and
means carried at least in part by said shoulders for holding said products in contact with said shoulders.

2. An assembly drum according to claim 1, in which said holding means comprises at least one vacuum valve for each shoulder.

3. An assembly drum according to claim 1, in which said shoulders are movable in a synchronized fashion so as to move further away from or closer to each other.

4. An assembly drum according to claim 1, in which said axial and radial movements of each shoulder are simultaneous.

5. An assembly drum according to claim 1, in which:
each shoulder comprises a plurality of circumferentially spaced lateral elements distributed regularly about said central axis;
and wherein said drum further comprises:
a barrel centered on said central axis;
a support on said barrel for each shoulder; and
a rocker arm associated with each of said circumferentially spaced lateral elements, each rocker arm being articulated at one end to a circumferentially spaced lateral element and at the other end to said support.

6. An assembly drum according to claim 5, in which each support comprises:
a slide which is axially movable relative to said barrel; and
an actuating cam on said slide for cooperative engagement with each rocker arm.

7. An assembly drum according to claim 5, in which said at least one vacuum valve for each shoulder is disposed inside a lateral element and opens out through an external surface of said lateral element.

8. An assembly drum according to claim 7, in which each shoulder includes a plurality of said vacuum valves distributed regularly over the circumference of the drum, each said vacuum valve being disposed in one of the lateral elements included in said shoulder.

9. An assembly drum according to claim 4, in which the axially central part of said generally cylindrical surface comprises a plurality of circumferentially spaced tiles which are partially superimposed on each other in the retracted position of the drum and which move radially along with said shoulders.
